(19) United States
(12) Patent Application Publication
(10) Pub. No.: US 2014/0247795 A1
(43) Pub. Date: Sep. 4, 2014

(54) APPARATUS AND METHOD FOR TRANSMITTING AND RECEIVING PERSISTENT SCHEDULING CHANGE INFORMATION IN WIRELESS COMMUNICATION SYSTEM

(71) Applicant: LG ELECTRONICS INC., Seoul (KR)

(72) Inventors: Jeongki Kim, Anyang-si (KR); Jinsam Kwak, Anyang-si (KR); Youngsoo Yuk, Anyang-si (KR)

(73) Assignee: LG ELECTRONICS INC., Seoul (KR)

(21) Appl. No.: 14/347,203

(22) PCT Filed: Oct. 29, 2012
(86) PCT No.: PCT/KR2012/008927

§ 371 Date: Mar. 25, 2014

Related U.S. Application Data
(60) Provisional application No. 61/552,430, filed on Oct. 27, 2011.
(60) Provisional application No. 61/557,322, filed on Nov. 8, 2011.

(30) Foreign Application Priority Data
Mar. 30, 2012 (KR) 10-2012-0033483

(51) Int. Cl. H04W 72/04; H04W 4/00

(52) U.S. Cl. CPC H04W 72/04; H04W 4/005
USPC 370/329

(57) ABSTRACT

A method and apparatus for transmitting and receiving persistent scheduling change information are disclosed. A machine-to-machine (M2M) device for receiving persistent scheduling change information in a wireless communication system includes a receiver for receiving, from a BS, a message comprising allocation period information including a persistent allocation period, wherein the message further comprises changed resource allocation information, when the allocation period information indicates temporal change or one time reallocation of uplink persistent allocation for the M2M device.

### TECHNICAL FIELD

The present invention relates to wireless communication and, more particularly, to an apparatus and method for transmitting and receiving persistent scheduling change information in a wireless communication system.

### BACKGROUND ART

Machine-to-machine (M2M) communication is communication between electronic devices as its appellation implies. While M2M communication means wired or wireless communication between electronic devices or communication between a human-controlled device and a machine in the broadest sense, these days M2M communication typically refers to wireless communication between electronic devices.

When the concept of M2M communication was introduced in the early 1990s, it was regarded merely as the concept of remote control or telematics and the market therefor was very limited. However, M2M communication has been drastically developed and the M2M communication market has attracted much attention all over the world over the past few years. Especially, M2M communication has a great influence in the fields of fleet management, remote monitoring of machines and facilities, smart metering for automatically measuring the working time of construction equipment and the consumption of heat or electricity, etc. in the Point Of Sales (POS) market and security-related applications. It is expected that M2M communication will find various uses in conjunction with legacy mobile communication, very high-speed wireless Internet or Wireless Fidelity (WiFi), and low-output communication solutions such as ZigBee and thus will extend to Business to Customer (B2C) markets beyond Business to Business (B2B) markets.

In the era of M2M communication, every machine equipped with a Subscriber Identity Module (SIM) card can be managed and controlled remotely because it is possible to transmit data to and receive data from the machine. For example, M2M communication is applicable to a very broad range including numerous terminals and equipment such as a car, a truck, a train, a container, an automatic vending machine, a gas tank, etc.

Conventionally, mobile stations are generally individually managed so that one-to-one communication was mainly performed between a base station and a mobile station. Assuming that numerous M2M devices communicate with the base station through one-to-one communication, network overload is expected due to signaling generated between each of the M2M devices and the base station. If M2M communication is rapidly spread and extensively used as described above, an overhead problem may occur due to communication between the M2M devices or between the M2M devices and the base station.

Before introduction of M2M devices, uplink (UL) persistent scheduling information of a BS for a mobile station (MS) has been defined. However, it is necessary to introduce regulations on details of UL persistent scheduling information in consideration of characteristics of the M2M devices. Although it is expected that the introduction of regulations on details of UL persistent scheduling information causes problems, such as collision, increase in scheduling complexity of a BS, generation of a resource hole, etc., when a resource region assigned according to long cycle persistent scheduling is occupied by existing MS traffic at a specific time, a solution to these problems has not been proposed yet.

### DISCLOSURE OF INVENTION

### Technical Problem

An object of the present invention is to provide a method for, at a BS, transmitting persistent scheduling change information in a wireless communication system.

Another object of the present invention is to provide a method for, at an M2M device, receiving persistent scheduling change information in a wireless communication system.

Another object of the present invention is to provide a BS for transmitting persistent scheduling change information in a wireless communication system.

Another object of the present invention is to provide an M2M device for receiving persistent scheduling change information in a wireless communication system.

The technical problems solved by the present invention are not limited to the above technical problems and those skilled in the art may understand other technical problems from the following description.

### Solution to Problem

The object of the present invention can be achieved by providing a method of transmitting persistent scheduling change information at a base station (BS) in a wireless communication system, the method including transmitting, to a machine-to-machine (M2M) device, a message comprising allocation period information including a persistent allocation period for the M2M device, wherein the allocation period information indicates temporary change or one time reallocation of uplink (UL) persistent allocation for the M2M device when the allocation period information is set to a specific value, and wherein the message further comprises changed resource allocation information when the allocation period information indicates a temporary change or one time reallocation of the UL persistent allocation for the M2M device. The set specific value may be 0b1111 and the message may be a UL M2M persistent allocation A-MAP IE (Information Element) message. The method may further include receiving UL data from the M2M device through a resource indicated by the changed resource allocation information. The method may further include receiving UL data through a persistent resource allocated before the message is received from the subsequent period, after the receiving of UL data from the M2M device through the resource indicated by the changed resource allocation information. The resource indicated by the changed resource allocation information may replace a resource, which was previously persistently allocated for the same subframe as a subframe in which the message is transmitted, temporarily or one time.

In another aspect of the present invention, there is provided a method of receiving persistent scheduling change information at a machine-to-machine (M2M) device in a wireless communication system, the method including receiving a message comprising allocation period information including a persistent allocation period from a BS, wherein the allocation period information indicates temporary change or one time reallocation of uplink persistent allocation for the M2M device when the allocation period information is set to a specific value, and wherein the message further comprises changed resource allocation information when the allocation period information indicates a temporary change or one time reallocation of uplink persistent allocation for the M2M device. The set specific value may be 0b1111. The message may be a UL M2M persistent allocation A-MAP IE (Information Element) message. The method may further include transmitting UL data to the BS through a resource indicated by the changed resource allocation information. The method may further include transmitting UL data through a persistent resource allocated before receiving the message from the subsequent period, after the transmitting of UL data to the BS through the resource indicated by the changed resource allocation information. The resource indicated by the changed resource allocation information may replace a resource, which was previously persistently allocated for the same subframe as a subframe in which the message is transmitted, temporarily or one time.

In another aspect of the present invention, there is provided a BS for transmitting persistent scheduling change information in a wireless communication system, which includes a transmitter for transmitting, to a machine-to-machine (M2M) device, a message comprising allocation period information including a persistent allocation period for the M2M device, wherein the allocation period information indicates temporary change or one time reallocation of uplink (UL) persistent allocation for the M2M device when the allocation period information is set to a specific value, and wherein the message further comprises changed resource allocation information when the allocation period information indicates a temporary change or one time reallocation of the UL persistent allocation for the M2M device.

The BS may further include a receiver for receiving UL data from the M2M device through a resource indicated by the changed resource allocation information. The receiver may receive the UL data through a persistent resource allocated before the message is received from the subsequent period after receiving the UL data from the M2M device through the resource indicated by the changed resource allocation information.

In another aspect of the present invention, there is provided a machine-to-machine (M2M) device for receiving persistent scheduling change information in a wireless communication system, which includes a receiver configured to receive from a BS, a message comprising allocation period information including a persistent allocation period, wherein the message further comprises changed resource allocation information when the allocation period information indicates a temporal change or one time reallocation of uplink persistent allocation for the M2M device. The M2M device may further include a transmitter configured to transmit UL data to the BS through a resource indicated by the changed resource allocation information. The M2M device may further include a processor configured to control the transmitter to transmit UL data through a persistent resource allocated before the message is received, after transmitting the UL data to the BS through the resource indicated by the changed resource allocation information, wherein the transmitter transmits UL data through the persistent resource allocated before the message is received, after transmitting the UL data to the BS.

### Advantageous Effects of Invention

According to the embodiments of the present invention, when a resource region allocated according to long cycle persistent scheduling is occupied by existing MS traffic at a specific time, a BS can change the location of the resource region efficiently one time or temporarily several times, thereby reducing scheduling complexity and preventing generation of a resource hole.

Furthermore, an M2M device can transmit UL data according to scheduling of the BS so as to improve communication performance.

The effects of the present invention are not limited to the above-described effects and other effects which are not described herein will become apparent to those skilled in the art from the following description.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a diagram schematically explaining the configuration of an M2M device and a BS according to an exemplary embodiment of the present invention;

FIG. 2 is a flowchart illustrating a method for, at an MS, transmitting UL data when a resource allocated by long cycle persistent scheduling is changed according to a first embodiment of the present invention; and

FIG. 3 is a flowchart illustrating a method for, at an M2M device, transmitting UL data when a resource allocated by long cycle persistent scheduling is changed according to a second embodiment of the present invention.

### BEST MODE FOR CARRYING OUT THE INVENTION

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details. For example, the following detailed description is given under the assumption that a mobile communication system conforming to Institute of Electrical and Electronics Engineers (IEEE) 802.16 and 3GPP (3rd Generation Partnership Project) is being used. However, the description is applicable to any other mobile communication system except for specific features inherent to IEEE 802.16 and 3GPP.

In some instances, known structures and devices are omitted or are shown in block diagram form, focusing on important features of the structures and devices, so as not to obscure the concept of the invention. The same reference numbers will be used throughout this specification to refer to the same or like parts.

In the following description, the term terminal generically refers to a mobile or fixed user terminal device such as a User Equipment (UE), a Mobile Station (MS), an Advanced Mobile Station (AMS), a machine to machine (M2M) device, etc. In addition, the term Base Station (BS) generically refers to any node at a network end which communicates with a UE, such as a Node B, an evolved Node B (eNode B), an Access Point (AP), etc.

In a mobile communication system, an MS can receive information from a BS on downlink and transmit data to the BS on uplink. Information transmitted from or received at the MS includes data and various types of control information. There are many physical channels depending on the types and usages of information transmitted from or received at MSs.

The embodiments of the present invention are applicable to a variety of wireless access systems such as Code Division Multiple Access (CDMA), Frequency Division Multiple Access (FDMA), Time Division Multiple Access (TDMA), Orthogonal Frequency Division Multiple Access (OFDMA), and Single Carrier Frequency Division Multiple Access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as IEEE 802.11 (Wireless Fidelity (Wi-Fi)), IEEE 802.16 (Worldwide interoperability for Microwave Access (WiMAX)), IEEE 802-20, Evolved UTRA (E-UTRA), etc. UTRA is a part of Universal Mobile Telecommunications System (UMTS). 3GPP LTE is a part of Evolved UMTS (E-UMTS) using E-UTRA, employing OFDMA for downlink and SC-FDMA for uplink. LTE-A is an evolution of 3GPP LTE.

Hereinafter, M2M communication refers to communication between Mobile Stations (MSs) via a Base Station (BS), between a BS and MSs without human intervention, or between M2M devices. Accordingly, M2M devices refer to MSs which can support the above M2M communication. An Access Service Network (ASN) for an M2M service is defined as an M2M ASN and a network entity communicating with M2M devices is called an M2M server. The M2M server executes an M2M application and provides an M2M specific service for one or more M2M devices. An M2M feature indicates the feature of an M2M application and one or more features may be necessary to provide the application. An M2M device group refers to a group of M2M devices which share one or more common features.

Devices performing communication according to an M2M scheme (which may be called M2M devices, M2M communication devices, Machine Type Communication (MTC) devices, etc.) will increase in number in a given network as machine application types thereof increase. Machine application types under consideration are (1) security; (2) public safety; (3) tracking and tracing; (4) payment; (5) healthcare; (6) remote maintenance and control; (7) metering; (8) consumer devices; (9) fleet management in Point Of Sale (POS)-related and security-related application markets; (10) communication between devices at a vending machine; (11) remote control of machines and facilities and smart metering for automatically measuring the operation time of construction machines and facilities and heat or power consumption; and (12) surveillance video communication, which should not be construed as limiting the present invention. Besides, many other machine application types are being discussed.

Another feature of M2M devices is that they have low mobility, that is, they seldom move once installed. In other words, the M2M devices are stationary for a considerably long time. An M2M communication system may simplify or optimize mobility related operations for a specific M2M application having a fixed location, such as secured access and surveillance, public safety, payment, remote maintenance and control, and metering.

Hereinafter, the exemplary embodiments of the present invention will be described when M2M communication is applied to a wireless communication system (e.g. IEEE 802.16e/m). However, the present invention is not limited thereto and is applicable to other wireless communication systems such as 3GPP LTE systems.

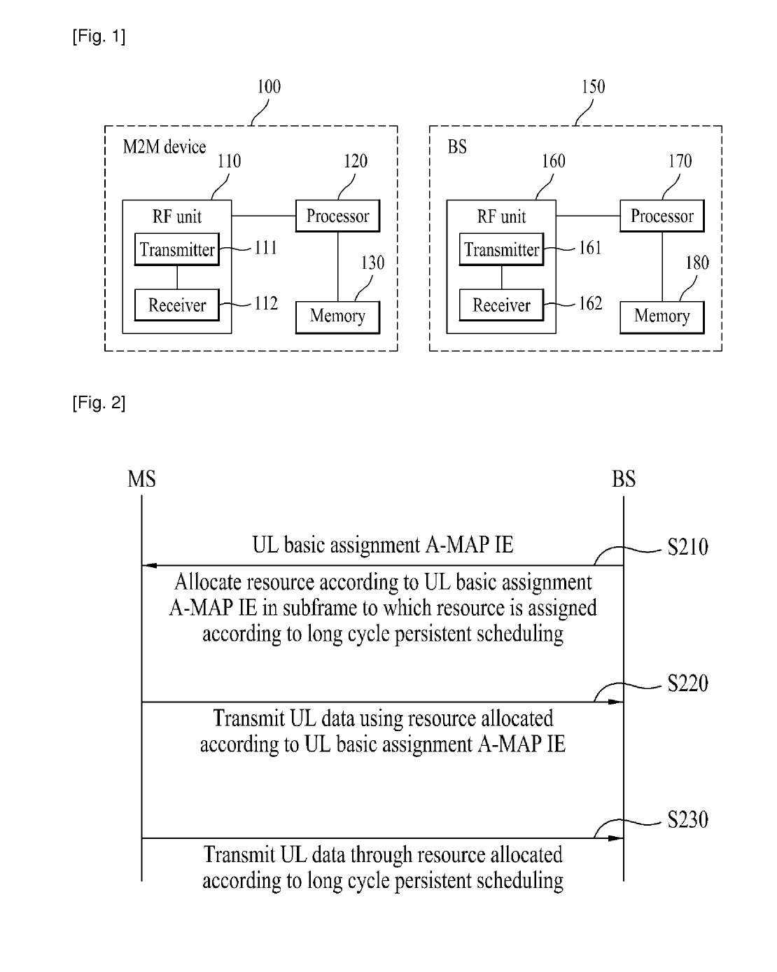

FIG. 1 is a diagram schematically explaining the configuration of an M2M device and a BS according to an exemplary embodiment of the present invention.

Referring to FIG. 1, an M2M device 100 (which may be called an M2M communication device) may include a Radio Frequency (RF) unit 110 and a processor 120. A BS 150 may include an RF unit 160 and a processor 170. The M2M device 100 and the BS 150 may selectively include memories 130 and 180, respectively. The RF units 110 and 160 may respectively include transmitters 111 and 161, and receivers 112 and 162. The transmitter 111 and the receiver 112 of the M2M device 100 are configured to transmit and receive signals to and from the BS 150 and other M2M devices. The processor 120 is functionally connected to the transmitter 111 and the receiver 112 so that the processor 120 may control the transmitter 111 and the receiver 112 to exchange signals with other devices. The processor 120 may process signals to be transmitted and transmit the processed signals to the transmitter 111. The processor 120 may process signals received by the receiver 112. If necessary, the processor 120 may store information included in exchanged messages in the memory 130. With such a configuration, the M2M device 100 may perform methods of various embodiments of the present invention which will be described below.

Meanwhile, although not shown in FIG. 1, the M2M device 100 may additionally include a variety of configurations according to an application type thereof. For example, if the M2M device 100 is for smart metering, the M2M device 100 may include an additional configuration for power measurement, and an operation for such power measurement may be controlled by the processor 120 shown in FIG. 1 or an additionally configured processor (not shown).

Although, in FIG. 1, the case in which communication between the M2M device 100 and the BS 150 is performed is shown by way of example, an M2M communication method according to the present invention may be performed between one or more M2M devices, and each device may carry out methods according to various embodiments, which will be described below, with the same configuration as that of the device shown in FIG. 1.

The transmitter 161 and the receiver 162 of the BS 150 are configured to transmit and receive signals to and from other BSs, M2M servers, and M2M devices. The processor 170 is functionally connected to the transmitter 161 and the receiver 162 so that the processor 170 may control the transmitter 161 and the receiver 162 to exchange signals with other devices. The processor 170 may process signals to be transmitted and transmit the processed signals to the transmitter 161. The processor 170 may process signals received by the receiver 162. If necessary, the processor 170 may store information included in exchanged messages in the memory 180. With such a configuration, the BS 150 may perform methods of various embodiments of the present invention which will be described below.

The processors 120 and 170 of the M2M device 110 and the BS 150 direct (e.g. control, adjust, manage, etc.) operations of the M2M 110 and the BS 150, respectively. The processors 120 and 170 may be respectively connected to the memories 130 and 180 which store program codes and data. The memories 130 and 180 connected respectively to the processors 120 and 170 store operating systems, applications, and general files.

Each of the processors 120 and 170 of the present invention may be called a controller, a microcontroller, a microcomputer, etc. Meanwhile, each of the processors 120 and 170 may be implemented by hardware, firmware, software, or combinations thereof. When the embodiments of the present invention are implemented using hardware, Application Specific Integrated Circuits (ASICs), Digital Signal Processors (DSPs), Digital Signal Processing Devices (DSPDs), Programmable Logic Devices (PLDs), Field Programmable Gate Arrays (FPGAs), or the like, devised to perform the present invention, may be included in the processors 120 and 170.

Meanwhile, when the embodiments of the present invention are implemented using firmware or software, the firmware or software may be configured to include a module, a procedure, or a function which performs the function or operation of the present invention. The firmware or software configured to be able to perform the present invention may be included in the processors 120 and 170 or may be stored in the memories 130 and 180 so as to be executed by the processors 120 and 170.

A description will be given of persistent scheduling in an IEEE 802.16m system.

Persistent allocation is used to reduce allocation overhead for connections having a periodic traffic pattern and a relatively fixed payload size. To persistently allocate resources to an MS, a BS transmits a downlink (DL) persistent allocation A-MAP IE for DL allocation and an uplink (UL) persistent allocation A-MAP IE for UL allocation to the MS. If essential flow information is available for UL persistent allocation, the MS needs to give high priority to a service flow intended to carry data over the allocated resources through HARQ channel mapping, for example.

A configuration parameter of a persistently allocated resource must be maintained by the BS and the MS until persistent allocation is de-allocated or changed, or an error event is generated. Persistent scheduling does not include arrangements for HARQ (Hybrid Automatic Repeat request) retransmission of data initially transmitted using persistently allocated resources. A resource for DL retransmission is allocated using a DL basic assignment A-MAP IE. A resource for UL retransmission is allocated using a UL basic assignment A-MAP IE only when control information is changed.

An allocation mechanism will now be briefly described.

For persistent allocation in DL/UL, the BS needs to transmit a DL/UL persistent allocation A-MAP IE message. Persistent allocation of a resource is started at an AAI subframe indicated by the DL/UL persistent allocation A-MAP IE message and repeated after an allocation period set in the DL/UL persistent allocation A-MAP IE. A configuration parameter of a persistently allocated resource is maintained for each DL/UL persistent allocation A-MAP IE. Values of an ACID (corresponding to a HARQ channel identifier) and an N_ACID set in the DL/UL persistent allocation A-MAP IE are used together to describe implicit cycling of the ACID.

In initial transmission along with the DL/UL persistent allocation A-MAP IE, an ACID of a HARQ burst is set to a value described in initial_ACID field of the DL/UL persistent allocation A-MAP IE. From the next new transmission, the ACID of the HARQ burst increases by 1 and cycles in the range of initial_ACID, Mod (Initial_ACID+N_ACID)-1, 16. Here, initial_ACID is a start ACID value in initial transmission. If a retransmission process for a previous HARQ burst is not completed before a new HARQ burst having the same ACID is transmitted, the retransmission process for the previous HARQ burst is ended and the new HARQ burst is overridden.

The configuration parameter of the persistent allocation resource may be changed in order to facilitate link adaptation and avoid generation of a resource hole. To change persistent allocation, the BS transmits the DL persistent allocation A-MAP IE for DL allocation and the UL persistent allocation A-MAP IE for UL allocation to the MS. When the MS has an existing persistent allocation in a specific AAI subframe, the MS receives a new persistent allocation in the same AAI subframe and the new persistent allocation replaces the previous allocation (that is, the previous persistent allocation is de-allocated).

When the BS reallocates a persistent allocation resource in DL by transmitting the DL persistent allocation A-MAP IE, a different HARQ feedback channel is assigned according to the persistent allocation A-MAP IE used for retransmission. If an AKC signal for an allocated DL data burst is detected from a newly allocated HARQ feedback channel, the BS assumes that the DL persistent allocation A-MAP IE signaled for retransmission has been successfully received. If the ACK signal is not detected, the same DL persistent allocation A-MAP IE for retransmission can be retransmitted after the subsequent allocation period.

When a data burst identified and reallocated by a UL persistent allocation A-MAP IE is successfully decoded, the BS assumes that the UL persistent allocation A-MAP IE that signals reallocation has been successfully received. If the reallocated data burst is not successfully decoded, the same reallocation UL A-MAP IE can be retransmitted after the subsequent period.

A de-allocation mechanism will now be briefly described.

To de-allocate persistent allocation in DL/UL, the BS transmits a DL/UL persistent allocation A-MAP IE message to the MS. When an allocation period field is set to 0b00 in the DL/UL persistent allocation A-MAP IE message, a resource persistently allocated according to the DL/UL persistent allocation A-MAP IE message is deallocated in a referenced DL/UL AAI subframe and the BS and the MS end persistent allocation. When the BS transmits the DL persistent allocation A-MAP IE (PA A-MAP IE) to the MS in order to de-allocate the resource persistently allocated in DL, a different HARQ feedback channel is assigned according to the persistent allocation A-MAP IE used for de-allocation. The MS transmits an AKC signal to the BS in order to indicate that the DL persistent allocation A-MAP IE message that signals de-allocation in the newly allocated HARQ feedback channel has been successfully received. The BS may retransmit the same de-allocation DL persistent allocation A-MAP IE message to the MS after the subsequent allocation period when the ACK is not received from the MS.

Asynchronous HARQ retransmission is used for DL persistent allocation. The DL basic allocation A-MAP IE message is transmitted to signal control information for HARQ retransmission. Synchronous HARQ retransmission is used for UL persistent allocation. The UL basic allocation A-MAP IE message is transmitted to signal control information for HARQ retransmission.

An error handling procedure will now be briefly described.

For HARQ enabled retransmission, an ACK signal is transmitted in order to indicate successful decoding of a data burst and a NACK signal is transmitted in order to signal failure of decoding of a burst transmitted on DL/UL. When an AKC signal with respect to a data burst identified by a DL persistent allocation A-MAP IE message is detected from a HARQ feedback channel assigned to a related HARQ process, the BS assumes that the MS has correctly received the DL persistent allocation A-MAP IE message. If an initial data burst identified by a UL persistent allocation A-MAP IE message is successfully decoded without additional transmission of a UL basic allocation A-MAP IE message for retransmission, the BS assumes that the UL persistent allocation A-MAP IE message has been successfully received.

When null detection is used, if the ACK or NACK signal is not present in a HARQ feedback channel allocated according to the DL persistent allocation A-MAP IE message for the data burst, the BS assumes that the MS has not received the DL persistent allocation A-MAP IE message and may retransmit the DL persistent allocation A-MAP IE message after the subsequent allocation period.

When persistent allocation is de-allocated in DL/UL, the BS signals HARQ feedback allocation through the DL/UL persistent allocation A-MAP IE message. The HARQ feedback allocation is used to identify a HARQ channel.

An ACK signal for the DL/UL persistent allocation A/MAP IE message that signals de-allocation is transmitted. When the ACK signal is not present (in case of null detection), the BS may retransmit the same DL/UL persistent allocation A-MAP IE message that signals de-allocation after the subsequent allocation period upon assuming that the MS has not received the DL/UL persistent allocation A-MAP IE message.

In the case of absence of a UL data burst in the resource assigned according to the UL persistent allocation A-MAP IE message, the UL data burst transmitted by the MS cannot be detected as a null signal while the UL data burst is not successfully decoded by the BS. In this case, the BS may transmit the same UL persistent allocation A-MAP IE message after the subsequent allocation period on the assumption that the MS has not successfully received the UL persistent allocation A-MAP IE message. To ensure successful reception of resource allocation information for subsequent persistent allocation, the initial data burst identified by the UL persistent allocation A-MAP IE message cannot be successfully decoded after N_MAX_ReTX HARQ retransmission, the subsequent persistent allocation cannot be successfully decoded and the same UL persistent allocation A-MAP IE message can be retransmitted after the subsequent allocation period.

The following table 1 shows an exemplary DL persistent allocation A-MAP IE message format.

TABLE 1

| Syntax | Size(bit) | Value/Description |
|---|---|---|
| DL persistent allocation A- | | |
| MAP IE ( ) { | | |
| A-MAP IE Type | 4 | DL Persistent Allocation A-MAP_IE |
| Allocation Period | 2 | Period of persistent allocation If (Allocation |
| | | Period == 0b00), it indicates the deallocation |
| | | of persistent resource. 0b00: deallocation |
| | | 0b01: 2 frames 0b10: 4 frames 0b11: 6 |
| | | frames |
| if (Allocation | | |
| Period==0b00){ | | |
| Resource Index | 11 | Confirmation of the resource index for a |
| | | previously assigned persistent resource that |
| | | has been deallocated. 512 FFT size: 0 in first |
| | | 2 MSB bits + 9 bits for resource index1024 |
| | | FFT size: 11 bits for resource index2048 FFT |
| | | size: 11 bits for resource indexResource |
| | | index includes location and allocation size |
| Long TTI Indicator | 1 | Indicates number of AAI subframes spanned |
| | | by the allocated resource. 0b0: 1 AAI |
| | | subframe (default) 0b1: 4 DL AAI subframes |
| | | for FDD or all DL AAI subframes for TDD |
| HFA | 6 | Explicit Index for HARQ Feedback A1- |
| | | location to acknowledge receipt of deal- |
| | | location A-MAP IE |
| Reserved | 16 | Reserved bits |
| } else if (Allocation Period | | |
| != 0b00){ | | |
| IsizeOffset | 5 | Offset used to compute burst size index |
| MEF | 2 | |
| if (MEF == 0b01){ | | |
| . . . | . . . | . . . |
| } | | |
| Resource Index | 11 | Confirmation of the resource index for a |
| | | previously assigned persistent resource that |
| | | has been deallocated. 512 FFT size: 0 in first |
| | | 2 MSB bits + 9 bits for resource index1024 |
| | | FFT size: 11 bits for resource index2048 FFT |
| | | size: 11 bits for resource indexResource |
| | | index includes location and allocation size |
| Long TTI Indicator | 1 | Indicates number of AAI subframes spanned |
| | | by the allocated resource. 0b0: 1 AAI |
| | | subframe (default) 0b1: 4 DL AAI subframes |
| | | for FDD or all DL AAI subframes for TDD |
| HFA | 3 | HARQ Feedback Allocation |
| N_ACID | 2 | Number of ACIDs for implicit cycling |
| | | ofHARQ channel identifier. 0b00: 10b01: |
| | | 20b10: 30b11: 4 |
| Initial_ACID | 4 | Initial value of HARQ channel identifier |
| | | forimplicit cycling of HARQ channel |
| | | identifiers. |
| Reserved | 2 | Reserved bits |
| } | | |
| } | | |

Referring to Table 1, the DL persistent allocation A-MAP IE message may include an A-MAP IE type field that indicates an A-MAP IE type, and an allocation period field. When the allocation period field is set to 0b00 which indicates de-allocation of persistent resources, the DL persistent allocation a-MAP IE message may include a resource index field that confirms a resource index for a previously assigned persistent resource that has been de-allocated, a long TTL indicator field that indicates the number of AAI subframes spanned by the allocated resource, and a HARQ feedback allocation (HFA) field that indicates an explicit index for HARQ feedback allocation to acknowledge receipt of de-allocation A-MAP IE.

In a case other than the case in which the allocation period field is set to 0b00, the DL persistent allocation a-MAP IE message may include the resource index field, the long TTI indicator field that indicates the number of AAI subframes spanned by the allocated resource, the HFA field that indicates HARQ feedback allocation, an N_ACID field that indicates the number of ACIDs for implicit cycling of HARQ channel identifier, and an initial_ACID field that indicates an initial value of a HARQ channel identifier for implicit cycling of HARQ channel identifiers.

The following table 2 shows an exemplary UL persistent allocation A-MAP IE message format.

TABLE 2

| Syntax | Size(bit) | Value/Description |
|---|---|---|
| UL persistent allocation A- | | |
| MAP IE ( ) { | | |
| A-MAP IE Type | 4 | UL Persistent Allocation A-MAP_IE |
| Allocation Period | 2 | Period of persistent allocation If (Allocation |
| | | Period == 0b00), it indicates the deallocation |
| | | of persistent resource. 0b00: deallocation |
| | | 0b01: 2 frames 0b10: 4 frames 0b11: 6 frames |
| if (Allocation | | |
| Period==0b00){ | | |
| Resource Index | 11 | Confirmation of the resource index for a |
| | | previously assigned persistent resource that |
| | | has been deallocated512 FFT size: 0 in first |
| | | 2 MSB bits + 9 bits for resource index1024 |
| | | FFT size: 11 bits for resource index2048 |
| | | FFT size: 11 bits for resource indexResource |
| | | index includes location and allocation size |
| TTI and Relevance | 2 | Indicates the TTI type and the location of |
| | | UL subframe relevant to this A-MAP. 0b00: |
| | | long TTI0b01: default TTI, the first UL |
| | | subframe relevant to this A-MAP0b10: |
| | | default TTI, the second UL subframerelevant |
| | | to this A-MAP0b11: default TTI, the third |
| | | UL subframe relevant to this A-MAP0b10 |
| | | and 0b11 are only applicable if the number |
| | | of DL AAI subframes is less than the |
| | | number of UL AAI subframes in TDD |
| | | mode. |
| HFA | 6 | Explicit Index for HARQ Feedback A1- |
| | | location to acknowledge receipt of deal- |
| | | location A-MAP IE |
| Reserved | 16 | Reserved bits |
| } else if (Allocation Period | | |
| != 0b00){ | | |
| IsizeOffset | 5 | Offset used to compute burst size index |
| Mₜ | 1 | Number of streams in transmission up to 2 |
| | | streams per AMS supported Nₜ: Number of |
| | | transmit antennas at the AMS 0b0: 1 stream |
| | | 0b1: 2 streams |
| if (MEF == 0b01){ | | |
| . . . | . . . | . . . |
| Resource Index | 11 | 512 FFT size: 0 in first 2 MSB bits + 9 bits |
| | | for resource index 1024 FFT size: 11 bits for |
| | | resource index 2048 FFT size: 11 bits for |
| | | resource index Resource index includes |
| | | location and allocation size |
| TTI and Relevance | 2 | Indicates the TTI type and the location of |
| | | UL subframe relevant to this A-MAP. 0b00: |
| | | long TTI0b01: default TTI, the first UL |
| | | subframe relevant to this A-MAP0b10: |
| | | default TTI, the second UL subframerelevant |
| | | to this A-MAP0b11: default TTI, the third |
| | | UL subframe relevant to this A-MAP0b10 |
| | | and 0b11 are only applicable if the number |
| | | of DL AAI subframes is less than the |
| | | number of UL AAI subframes in TDD |
| | | mode. |
| HFA | 3 | HARQ Feedback Allocation |
| N_ACID | 2 | Number of ACIDs for implicit cycling |
| | | ofHARQ channel identifier. 0b00: 10b01: |
| | | 20b10: 30b11: 4 |
| Initial_ACID | 4 | Initial value of HARQ channel identifier for |
| | | implicit cycling of HARQ channel |
| | | identifiers. |
| Reserved | 1 | Reserved bits |
| } | | |
| } | | |

Referring to Table 2, the UL persistent allocation A-MAP IE message may include an A-MAP IE type field that indicates an A-MAP IE type, and an allocation period field. When the allocation period field is set to 0b00 which indicates de-allocation of persistent resource, the UL persistent allocation a-MAP IE message may include a resource index field that confirms a resource index for a previously assigned persistent resource that has been de-allocated, a TTI and relevance field that indicates the TTI type and the location of UL subframe relevant to this A-MAP, and an HFA field that indicates an explicit index for HARQ feedback allocation to acknowledge receipt of de-allocation A-MAP IE.

In a case other than the case in which the allocation period field is set to 0b00, the UL persistent allocation a-MAP IE message may include an IsizeOffset field that indicates an offset used to compute a burst size index, an Mt field that indicates the number of streams in transmission of up to 2 streams per AMS supported, the resource index field, the TTI and relevance field that indicates the TTI type and the location of UL subframe relevant to this A-MAP, the HFA field that indicates HFA feedback allocation, an N_ACID field that indicates the number of ACIDs for implicit cycling of HARQ channel identifier, and an initial_ACID field that indicates an initial value of HARQ channel identifier for implicit cycling of HARQ channel identifiers.

A description will be given of persistent scheduling in IEEE 802.16m advanced air interface (AAI) in order to explain long cycle persistent scheduling in M2M.

In IEEE 802.16m AAI systems, long cycle allocation is used for high priority M2M connection having a periodic traffic pattern and relatively fixed payload size. To persistently assign a resource to a fixed M2M device, the BS may transmit, to the M2M device, a UL M2M persistent allocation A-MAP IE for UL allocation having a long allocation cycle.

A UL resource allocated according to long cycle persistent scheduling may be temporarily changed. To temporarily change UL persistent allocation, the BS may set an allocation period to 0b1111, for example, and transmit the UL M2M persistent allocation A-MAP IE to the M2M device. When the M2M device has an existing persistent allocation in a specific AAI subframe and receives a new resource allocation in the same AAI subframe by receiving the UL M2M persistent allocation A-MAP IE having the allocation period set to 0b1111, the new resource allocation replaces the original persistent allocation only in the AAI subframe (that is, the original persistent allocation is restarted from the next allocation period).

A de-allocation mechanism will now be described.

In de-allocation of long cycle persistent scheduling according to the UL M2M persistent allocation a-MAP IE message, when a de-allocation type is set to 0b0 (i.e. permanent de-allocation), a persistent resource allocated by the UL M2M persistent allocation A-MAP IE message should be de-allocated in a reference UL subframe and the BS and the M2M device need to finish persistent allocation. If not (i.e. in case of one-time de-allocation), the persistent resource allocated by the UL M2M persistent allocation A-MAP IE message should be de-allocated one time in the reference UL subframe and the BS and the M2M device need to maintain previous persistent allocation.

The following table 3 shows an exemplary UL M2M persistent allocation A-MAP IE message format.

TABLE 3

| Syntax | Size (bit) | Value/Description |
|---|---|---|
| UL persistent allocation A- | | |
| MAP IE ( ) { | | |
| A-MAP IE Type | 4 | UL M2M Persistent Allocation A- |
| | | MAP_IE |
| Allocation Period | 4 | Period of persistent allocation for M2M: |
| | | Bit 0~20b000: deallocation 0b001: 2 |
| | | frames 0b010: 4 frames 0b011: 6 frames |
| | | 0b100: 5 superframes 0b101: 10 super |
| | | frames 0b110: 25 superframes 0b111: |
| | | 50 superframes 0b1000-0b1110: Reserved |
| | | Bit 3: Reserved |
| if (Allocation | | |
| Period==0b00){ | | |
| Resource Index | 11 | Confirmation of the resource index for a |
| | | previously assigned persistent resource that |
| | | has been deallocated512 FFT size: 0 in first 2 |
| | | MSB bits + 9 bits for resource index1024 |
| | | FFT size: 11 bits for resource index2048 |
| | | FFT size: 11 bits for resource index |
| | | Resource index includes location and |
| | | allocation size |
| TTI and Relevance | 2 | Indicates the TTI type and the location of |
| | | UL subframe relevant to this A- |
| | | MAP. 0b00: long TTI0b01: default TTI, the |
| | | first UL subframe relevant to this A- |
| | | MAP0b10: default TTI, the second UL |
| | | subframe relevant to this A-MAP0b11: |
| | | default TTI, the third UL subframe relevant |
| | | to this A-MAP |
| HFA | 6 | Explicit Index for HARQ Feedback A1- |
| | | location to acknowledge receipt of deal- |
| | | location A-MAP IE |
| Reserved | 13 | Reserved bits |
| } else if (Allocation Period | | |
| != 0b000){ | | |
| IsizeOffset | 5 | Offset used to compute burst size index |
| Resource Index | 11 | Confirmation of the resource index for a |
| | | previously assigned persistent resource that |
| | | has been deallocated512 FFT size: 0 in first |
| | | 2 MSB bits + 9 bits for resourceindex1024 |
| | | FFT size: 11 bits for resource index2048 |
| | | FFT size: 11 bits for resource index |
| | | Resource index includes location and |
| | | allocation size |
| TTI and Relevance | 2 | Indicates the TTI type and the location of |
| | | UL subframe relevant to this A- |
| | | MAP.0b00: long TTI0b01: default TTI, the |
| | | first UL subframe relevant to this A- |
| | | MAP0b10: default TTI, the second UL |
| | | subframe relevant to this A-MAP0b11: |
| | | default TTI, the third UL subframe relevant |
| | | to this A-MAP |
| HFA | 3 | HARQ Feedback Allocation |
| N_ACID | 2 | Number of ACIDs for implicit cycling |
| | | ofHARQ channel identifier. 0b00: 10b01: |
| | | 20b10: 30b11: 4 |
| Initial_ACID | 4 | Initial value of HARQ channel identifier |
| | | forimplicit cycling of HARQ channel |
| | | identifiers. |
| Reserved | 5 | Reserved bits |
| } | | |
| } | | |

Referring to Table 3, the UL persistent allocation A-MAP IE message may include an A-MAP IE type field that indicates an A-MAP IE type, and an allocation period field. When the allocation period field is set to 0b0000, it may indicate de-allocation.

When the allocation period field is set to 0b0000 which indicates de-allocation of persistent resource, the UL persistent allocation a-MAP IE message may include a resource index field that confirms a resource index for a previously assigned persistent resource that has been de-allocated, a TTI and relevance field that indicates the TTI type and the location of UL subframe relevant to this A-MAP, and an HFA field that indicates an explicit index for HARQ feedback allocation to acknowledge receipt of de-allocation A-MAP IE.

In a case other than the case in which the allocation period field is set to 0b0000, the UL persistent allocation a-MAP IE message may include an IsizeOffset field that indicates an offset used to compute a burst size index, the resource index field, the TTI and relevance field that indicates the TTI type and the location of UL subframe relevant to this A-MAP, the HFA field that indicates HFA feedback allocation, an N_ACID field that indicates the number of ACIDs for implicit cycling of HARQ channel identifier, and an initial_ACID field that indicates an initial value of HARQ channel identifier for implicit cycling of HARQ channel identifiers.

To change persistent allocation of persistent scheduling in the IEEE 802.16m system, the BS transmits the DL persistent allocation a-MAP IE message or UL persistent allocation A-MAP IE message. When the M2M device which has been assigned persistent allocation in a specific subframe is provided with a new persistent allocation through the DL/UL persistent allocation A-MAP IE message, the M2M device determines that the new persistent allocation replaces the previous persistent allocation and de-allocates the previous persistent allocation.

Most traffic for the M2M application has lower priority than conventional human type data (e.g. voice over Internet protocol (VoIP), streaming, video service, etc.). When a region allocated according to long cycle persistent scheduling at a specific time is occupied by human type traffic, the BS needs to change the corresponding location one time. In this case, if a previous allocation is overlaid with a new allocation, a resource assigned according to the new allocation is determined as a subsequent resource location. This increases not only scheduling complexity of the BS but also the number of resource holes, to result in inefficient use of resources.

Accordingly, the present invention proposes methods for temporarily changing a resource allocated by long cycle persistent scheduling when the allocated resource is used for a different purpose at a specific time.

### First Embodiment

FIG. 2 is a flowchart illustrating a method of transmitting UL data at an MS when a resource allocated according to long cycle persistent scheduling is changed according to a first embodiment of the present invention.

Referring to FIG. 2, when a BS attempts to change the location of a resource at a time when the resource is allocated according to long cycle persistent scheduling, the BS transmits a UL basic assignment A-MAP IE to the MS (S210). If the MS is assigned a resource by the BS according to the UL basic assignment A-MAP IE in an AAI subframe to which a resource is allocated according to long cycle persistent scheduling, the MS transmits UL data using the resource allocated according to the UL basic assignment A-MAP IE instead of the resource allocated according to long cycle persistent scheduling in the corresponding subframe (S220).

The MS may transmit UL data through the resource allocated according to long cycle persistent scheduling from the subsequent period (S230).

### Second Embodiment

When the BS attempts to change the location of a resource at a time when the resource is allocated according to long cycle persistent scheduling, the BS can change the location of the resource using a UL M2M persistent allocation A-MAP IE message used for the long cycle persistent scheduling. In this case, the BS may include a field indicating temporary change in the UL M2M persistent allocation A-MAP IE message. The following table 4 shows an exemplary UL M2M persistent allocation A-MAP IE.

TABLE 4

| | Size | |
|---|---|---|
| Syntax | (bits) | Value/Description |
| UL M2M | — | — |
| Persistent | | |
| Allocation | | |
| A-MAP | | |
| IE( ) { | | |
| A-MAP IE Type | 4 | UL M2M Persistent Allocation A-MAP_IE |
| Allocation Period | 4 | Period of persistent allocation for |
| | | M2M: 0b0000: deallocation0b0001: 2 |
| | | frames0b0010: 4 frames0b0011: 6 |
| | | frames0b0100: 5 superframes0b0101: |
| | | 10 superframes0b0110: 25 |
| | | superframes0b0111: 50 |
| | | superframes0b1000~0b1110: |
| | | reserved0b1111: |
| | | One time re-allocation |
| if (Allocation | — | — |
| Period== | | |
| 0b0000){ | | |
| Resource Index | 11 | Confirmation of the resource index for a |
| | | previously assigned persistent resource that |
| | | has been deallocated512 FFT size: 0 in first 2 |
| | | MSB bits + 9 bits for resource index1024 FFT |
| | | size: 11 bits for resource index2048 FFT size: |
| | | 11 bits for resource indexResource index |
| | | includes location and allocation size |
| TTI and | 2 | Indicates the TTI type and the location of UL |
| Relevance | | subframe relevant to this A-MAP. 0b00: long |
| | | TTI0b01: default TTI, the first UL subframe |
| | | relevant to this A-MAP0b10: default TTI, the |
| | | second UL subframerelevant to this A- |
| | | MAP0b11: default TTI, the third UL |
| | | subframe relevant to this A-MAP |
| HFA | 6 | Explicit Index for HARQ Feedback Al- |
| | | location to acknowledge receipt of deal- |
| | | location A-MAP IE |
| Reserved | 13 | Reserved bits |
| } else if | | |
| (Allocation | | |
| Period != | | |
| 0b0000){ | | |
| I_{sizeOffset} | 5 | Offset used to compute burst size index |
| Resource Index | 11 | 512 FFT size: 0 in first 2 MSB bits + 9 bits |
| | | for resource index1024 FFT size: 11 bits for |
| | | resource index2048 FFT size: 11 bits for |
| | | resource indexResource index includes |
| | | location and allocation size |
| TTI and | 2 | Indicates the TTI type and the location of UL |
| Relevance | | subframe relevant to this A-MAP. 0b00: long |
| | | TTI0b01: default TTI, the first UL subframe |
| | | relevant to this A-MAP0b10: default TTI, the |
| | | second UL subframerelevant to this A- |
| | | MAP0b11: default TTI, the third UL |
| | | subframe relevant to this A-MAP |
| HFA | 3 | HARQ Feedback Allocation |
| N_ACID | 2 | Number of ACIDs for implicit cycling |
| | | ofHARQ channel identifier. 0b00: 10b01: |
| | | 20b10: 30b11: 4 |
| Initial_ACID | 4 | Initial value of HARQ channel identifier for |
| | | implicit cycling of HARQ channel identifiers. |
| Reserved | 5 | Reserved bits |
| } | | |
| } | | |

Referring to Table 4, the UL M2M persistent allocation A-MAP IE message may include an A-MAP IE type field that indicates an A-MAP IE type, and an allocation period field. When the allocation period field (or allocation period information) is set to 0b1111, it indicates one time re-allocation. Other allocation period values may be set to 2 frames, 4 frames, 6 frames, 5 superframes, 10 superframes, 25 superframes, 50 superframes, etc.

When the M2M device has an existing persistent allocation in a specific time unit (e.g. a specific subframe) and receives a UL M2M persistent allocation A-MAP IE including new resource allocation information for the specific subframe, the M2M device may transmit UL data to the BS using a resource allocated according to the corresponding UL M2M persistent allocation A-MAP IE message and the processor 120 of the M2M device may control the transmitter 111 to transmit UL data to the BS using previous persistent allocation from the subsequent period. That is, the resource newly allocated according to the UL M2M persistent allocation A-MAP IE message is valid only in the current subframe in which the UL M2M persistent allocation A-MAP IE is received.

When the allocation period field is set to 0b0000 to indicate de-allocation of persistent allocation, the UL M2M persistent allocation A-MAP IE message may include a resource index field that confirms a resource index for a previously assigned persistent resource that has been de-allocated, a TTI and relevance field that indicates the TTI type and the location of UL subframe relevant to this A-MAP, and an HFA field that indicates an explicit index for HARQ feedback allocation to acknowledge receipt of de-allocation A-MAP IE.

In a case other than the case in which the allocation period field is set to 0b0000, the UL M2M persistent allocation A-MAP IE message may include an IsizeOffset field that indicates an offset used to compute a burst size index, the resource index field, the TTI and relevance field that indicates the TTI type and the location of UL subframe relevant to this A-MAP, the HFA field that indicates HFA feedback allocation, an N_ACID field that indicates the number of ACIDs for implicit cycling of HARQ channel identifier, and an initial_ACID field that indicates an initial value of HARQ channel identifier for implicit cycling of HARQ channel identifiers.

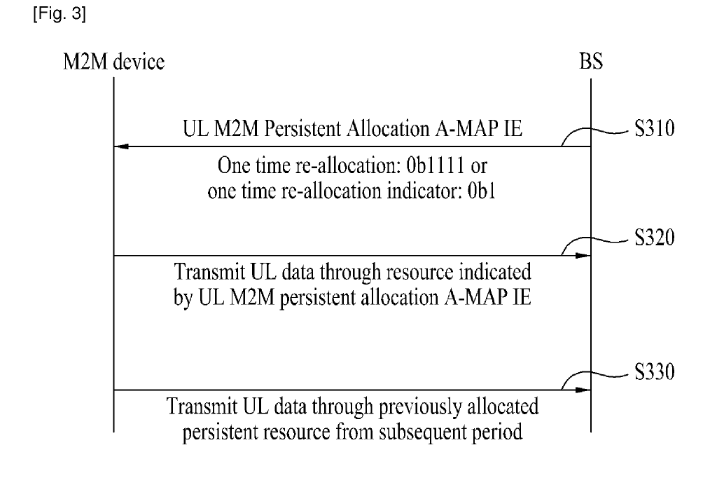

FIG. 3 is a flowchart illustrating a method of transmitting UL data at an M2M device when a resource allocated according to long cycle persistent scheduling is changed according to a second embodiment of the present invention.

Referring to FIG. 3, the BS may set the allocation period field to 0b1111 and transmit the UL M2M persistent allocation A-MAP IE message to the M2M device (S310). This indicates that a resource allocated for a specific subframe according to a previous UL M2M persistent allocation A-MAP IE is replaced by a resource allocated according to the currently transmitted UL M2M persistent allocation A-MAP IE one time.

That is, when the M2M device has a resource allocated according to long cycle persistent scheduling in a specific AAI subframe, if the M2M device receives the UL M2M persistent allocation A-MAP IE with the allocation period field set to 0b1111 for the same AAI subframe as the specific AAI subframe (S310), the resource (i.e. reallocated resource) indicated in the subframe in which the UL M2M persistent allocation A-MAP IE is received replaces the previously allocated persistent allocated resource. Accordingly, the M2M device can transmit UL data to the BS through the resource that replaces the previously allocated persistent resource (S320). In this case, the M2M device can transmit UL data through the resource that replaces the previously allocated persistent resource only one time.

The following table 5 shows another exemplary UL M2M persistent allocation A-MAP IE message.

TABLE 5

| Syntax | Size (bits) | Value/Description |
|---|---|---|
| UL M2M persistent allocation | — | — |
| A-MAP IE ( ) { | | |
| A-MAP IE type | 4 | UL M2M persistent allocation A-MAP |
| | | IE |
| Allocation Period | 4 | Period of persistent allocation for |
| | | M2M: 0b0000: de-allocation0b0001: 2 |
| | | frames0b0010: 4 frames0b0011: 6 |
| | | frames0b0100: 5 superframes0b0101: 10 |
| | | superframes0b0110: 25 super |
| | | frames0b0111: 50 superframes |
| | | 0b1000~0b1110: reserved0b1111: One |
| | | time re-allocation0b110: 25 superframes |
| | | 0b111: 50 superframes 0b1000-0b1110: |
| | | ReservedBit 3: Reserved |
| If (Allocation | — | — |
| Period==0b0000) | | |
| Resource Index | 11 | Confirmation of the resource index for a |
| | | previously assigned persistent resource |
| | | that has been de-allocated512 FFT size: |
| | | 0 in first 2 MSB bits + 9 bits for resource |
| | | index1024 FFT size: 11 bits for resource |
| | | index2048 FFT size: 11 bits for resource |
| | | indexResource index includes location |
| | | and allocation size |
| TTI and Relevance | 2 | Indicates the TTI type and the location of |
| | | UL subframe relevant to this A- |
| | | MAP. 0b00: long TTI0b01: default TTI, |
| | | the first UL subframe relevant to this A- |
| | | MAP0b10: default TTI, the second UL |
| | | subframe relevant to this A-MAP0b11: |
| | | default TTI, the third UL subframe |
| | | relevant to this A-MAP |
| HFA | 6 | Explicit Index for HARQ Feedback Allocation |
| | | to acknowledge receipt of de- |
| | | allocation A-MAP IE |
| Reserved | 13 | Reserved bits |
| } else if (Allocation | | |
| Period !=0b0000){ | | |
| I_{sizeOffset} | 5 | Offset used to compute burst size index |
| One-time reallocation | 1 | 1: Resource allocated to corresponding |
| indicator | | IE is valid only in the current subframe. |
| | | In this case, the above set allocation |
| | | period will be ignored. |
| Resource Index | 11 | Confirmation of the resource index for a |
| | | previously assigned persistent resource |
| | | that has been de-allocated512 FFT size: |
| | | 0 in first 2 MSB bits + 9 bits for resource |
| | | index1024 FFT size: 11 bits for resource |
| | | index2048 FFT size: 11 bits for resource |
| | | indexResource index includes location |
| | | and allocation size |
| TTI and Relevance | 2 | Indicates the TTI type and the location of |
| | | UL subframe relevant to this A- |
| | | MAP. 0b00: long TTI0b01: default TTI, |
| | | the first UL subframe relevant to this A- |
| | | MAP0b10: default TTI, the second UL |
| | | subframe relevant to this A-MAP0b11: |
| | | default TTI, the third UL subframe |
| | | relevant to this A-MAP |
| HFA | 3 | HARQ feedback allocation |
| N_ACID | 2 | Number of ACIDs for implicit cycling of |
| | | HARQ channel identifier0b00: 10b01: |
| | | 20b10: 30b11: 4 |
| Initial_ACID | 4 | Initial value of HARQ channel identifier |
| | | for implicit cycling of HARQ channel |
| | | identifiers |
| Reserved | 4 | Reserved bits |
| } | | |
| } | | |

Distinguished from Table 4 in which the allocation period field indicates one-time re-allocation, Table 5 defines a new field indicating one-time reallocation (e.g. one-time reallocation indicator field) which is included in the UL M2M persistent allocation A-MAP IE.

When the M2M device receives the UL M2M persistent allocation A-MAP IE, if the one-time reallocation indicator field indicates one-time reallocation (e.g. it is set to 1), the M2M device can transmit UL data to the BS using a resource indicated in the subframe in which the UL M2M persistent allocation A-MAP IE message is received, that is, reallocated resource (S320). That is, the resource allocated according to the UL M2M persistent allocation A-MAP IE is valid only in the current subframe. In this case, the previously set allocation period is abandoned.

### Third Embodiment

One time reallocation is temporary reallocation and may be modified as follows. The following table 6 shows another exemplary UL M2M persistent allocation A-MAP IE message according to the third embodiment of the present invention.

TABLE 6

| | Size | |
|---|---|---|
| Syntax | (bits) | Value/Description |
| UL M2M Persistent | — | — |
| Allocation | | |
| A-MAP_IE( ) { | | |
| A-MAP IE Type | 4 | UL M2M Persistent Allocation A- |
| | | MAP_IE |
| Allocation Period | 4 | Period of persistent allocation for |
| | | M2M: 0b0000: deallocation0b0001: 2 |
| | | frames0b0010: 4 frames0b0011: 6 |
| | | frames0b0100: 5 superframes0b0101: |
| | | 10 superframes0b0110: 25 super |
| | | frames0b0111: 50 superframes |
| | | 0b1000~0b1110: reserved0b1111: |
| | | Temporal re-allocation |
| if (Allocation | — | — |
| Period==0b0000){ | | |
| Resource Index | 11 | Confirmation of the resource index for |
| | | a previously assigned persistent |
| | | resource that has been deallocated512 |
| | | FFT size: 0 in first 2 MSB bits + 9 bits |
| | | for resource index1024 FFT size: 11 |
| | | bits for resource index2048 FFT size: |
| | | 11 bits for resource indexResource |
| | | index includes location and allocation |
| | | size |
| TTI and Relevance | 2 | Indicates the TTI type and the location |
| | | of UL subframe relevant to this A- |
| | | MAP.0b00: long TTI0b01: default |
| | | TTI, the first UL subframe relevant to |
| | | this A-MAP0b10: default TTI, the |
| | | second UL subframerelevant to this A- |
| | | MAP0b11: default TTI, the third UL |
| | | subframe relevant to this A-MAP |
| HFA | 6 | Explicit Index for HARQ Feedback |
| | | Allocation to acknowledge receipt of |
| | | deallocation A-MAP IE |
| Reserved | 13 | Reserved bits |
| } else if (Allocation | | |
| Period != | | |
| 0b0000){ | | |
| I_{sizeOffset} | 5 | Offset used to compute burst size |
| | | index |
| Resource Index | 11 | Confirmation of the resource index for |
| | | a previously assigned persistent |
| | | resource that has been deallocated512 |
| | | FFT size: 0 in first 2 MSB bits + 9 bits |
| | | for resourceindex1024 FFT size: 11 |
| | | bits for resource index2048 FFT size: |
| | | 11 bits for resource indexResource |
| | | index includes location and allocation |
| | | size |
| TTI and Relevance | 2 | Indicates the TTI type and the location |
| | | of UL subframe relevant to this A- |
| | | MAP .0b00: long TTI0b01: default |
| | | TTI, the first UL subframe relevant to |
| | | this A-MAP0b10: default TTI, the |
| | | second UL subframerelevant to this A- |
| | | MAP0b11: default TTI, the third UL |
| | | subframe relevant to this A-MAP |
| HFA | 3 | HARQ Feedback Allocation |
| N_ACID | 2 | Number of ACIDs for implicit cycling |
| | | ofHARQ channel identifier. 0b00: |
| | | 10b01: 20b10: 30b11: 4 |
| Initial_ACID | 4 | Initial value of HARQ channel |
| | | identifier for implicit cycling of |
| | | HARQ channel identifiers. |
| If (Allocation Period == | | |
| 0b1111) { | | |
| Num_re-allocation | | The number that the consecutive re- |
| | | allocations happen0b00: 10b01: 2 |
| | | 0b10: 30b11: 4 |
| Reserved | | |
| } else { | | |
| Reserved | 4 | Reserved bits |
| } | | |
| } | | |

Referring to Table 6, the UL M2M persistent allocation A-MAP IE message may include an allocation period field that indicates temporal reallocation (e.g. the allocation period field is set to 0b1111) and a Num_re-allocation field that indicates the number of consecutive re-allocations. The UL M2M persistent allocation A-MAP IE message can represent the number of consecutive persistent allocations changed by the current UL M2M persistent allocation A-MAP IE.

When the M2M device receives the UL M2M persistent allocation A-MAP IE message, as many previous persistent allocations as the number indicated by the Num_re-allocation field are replaced by the resource allocated according to the UL M2M persistent allocation A-MAP IE. After the last reallocation, persistent allocation is resumed with previous persistent allocation parameters from the subsequent period. That is, the M2M device and the BS reuse previous persistent allocation.

### Fourth Embodiment

To indicate temporal reallocation according to the UL M2M persistent allocation A-MAP IE, it is possible to newly define a temporal reallocation indicator field and include the temporal reallocation indicator field in the UL M2M persistent allocation A-AMP IE message rather than setting the allocation period field to a specific value (e.g. 0b1111).

The following table 7 shows an exemplary UL M2M persistent allocation A-MAP IE message according to the fourth embodiment of the present invention.

TABLE 7

| Syntax | Size (bits) | Value/Description |
|---|---|---|
| UL M2M persistent allocation | — | — |
| A-MAP IE ( ) { | | |
| A-MAP IE type | 4 | UL M2M persistent allocation A-MAP IE |
| Allocation Period | 4 | Period of persistent allocation for M2M: 0b0000: |
| | | de-allocation0b0001: 2 frames0b0010: 4 |
| | | frames0b0011: 6 frames0b0100: 5 super |
| | | frames0b0101: 10 superframes0b0110: 25 super |
| | | frames0b0111: 50 superframes |
| | | 0b1000~0b1110: reserved |
| If (Allocation | — | — |
| Period==0b0000) | | |
| Resource Index | 11 | Confirmation of the resource index for a |
| | | previously assigned persistent resource that has |
| | | been de-allocated512 FFT size: 0 in first 2 MSB |
| | | bits + 9 bits for resource index1024 FFT size: 11 |
| | | bits for resource index2048 FFT size: 11 bits for |
| | | resource indexResource index includes location |
| | | and allocation size |
| TTI and Relevance | 2 | Indicates the TTI type and the location of UL |
| | | subframe relevant to this A-MAP. 0b00: long |
| | | TTI0b01: default TTI, the first UL subframe |
| | | relevant to this A-MAP0b10: default TTI, the |
| | | second UL subframerelevant to this A-MAP0b11: |
| | | default TTI, the third UL subframe relevant to |
| | | this A-MAP |
| HFA | 6 | Explicit Index for HARQ Feedback Allocation to |
| | | acknowledge receipt of de-allocation A-MAP IE |
| Reserved | 13 | Reserved bits |
| } else if (Allocation | | |
| Period !=0b0000){ | | |
| I_{sizeOffset} | 5 | Offset used to compute burst size index |
| Resource Index | 11 | Confirmation of the resource index for a |
| | | previously assigned persistent resource that has |
| | | been de-allocated512 FFT size: 0 in first 2 MSB |
| | | bits + 9 bits for resource index1024 FFT size: 11 |
| | | bits for resource index2048 FFT size: 11 bits for |
| | | resource indexResource index includes location |
| | | and allocation size |
| TTI and Relevance | 2 | Indicates the TTI type and the location of UL |
| | | subframe relevant to this A-MAP. 0b00: long |
| | | TTI0b01: default TTI, the first UL subframe |
| | | relevant to this A-MAP0b10: default TTI, the |
| | | second UL subframerelevant to this A-MAP0b11: |
| | | default TTI, the third UL subframe relevant to |
| | | this A-MAP |
| HFA | 3 | HARQ feedback allocation |
| N_ACID | 2 | Number of ACIDs for implicit cycling of HARQ |
| | | channel identifier0b00: 10b01: 20b10: 30b11: 4 |
| Initial_ACID | 4 | Initial value of HARQ channel identifier for |
| | | implicit cycling of HARQ channel identifiers |
| Temporal re-allocation | 1 | 1: Indicates that resource allocated to corresponding |
| indicator | | IE temporarily replaces previous |
| | | persistent allocation. In this case, the above set allocation |
| | | period will be abandoned. |
| If (Temporal re- | | The number that the consecutive re-allocations |
| allocation indicator == | | happen0b00: 10b01: 2 0b10: 30b11: 4 |
| 0b1) { | | |
| Num_re-allocation | | The number that the consecutive re-allocations |
| | | happen0b00: 10b01: 2 0b10: 30b11: 4After the |
| | | last reallocation, M2M device or MS uses |
| | | previous persistent allocation. |
| Reserved | | |
| } else { | | |
| Reserved | 4 | Reserved bits |
| } | | |
| } | | |

Referring to Table 7, the UL M2M persistent allocation A-MAP IE message may include a temporal reallocation indicator field to indicate temporal reallocation.

If the temporal reallocation indicator field indicates temporal reallocation (e.g. the temporal reallocation indicator field is set to 0b1), the UL M2M persistent allocation A-MAP IE message may include information representing the number of consecutive persistent allocations that are changed according to the current UL M2M persistent allocation A-MAP IE. As many previous persistent allocations as the number indicated by a Num_re-allocation field are replaced by the resource allocated according to the UL M2M persistent allocation A-MAP IE. The M2M device transmits UL data to the BS through the resource replaced according to the UL M2M persistent allocation A-MAP IE. That is, the previous persistent allocations are replaced by the resource allocated according to the UL M2M persistent allocation A-AMP IE.

After the last reallocation, persistent allocation is resumed with previous persistent allocation parameters from the subsequent period. That is, the M2M device and the BS reuse the previous persistent allocations.

When the BS attempts to change the location of a resource allocated according to long cycle persistent scheduling at a specific time for persistent allocation for other traffic (VoIP traffic of another M2M device or MS) or for transmission of other traffic (real-time traffic of another M2M device or MS), if a resource to be assigned in the corresponding subframe is not present, the BS needs to de-allocate persistent allocation for the current subframe and then reallocate a resource to a frame following the current subframe. In this case, the BS has to inform the M2M device of de-allocation of persistent allocation in the current subframe. To achieve this, the BS may use the following method.

The BS transmits a UL basic assignment A-MAP IE to the M2M device having a resource index set to 0b00000000000. Upon reception of the UL M2M basic assignment A-MAP IE, the M2M device de-allocates the allocated persistent resource only at the corresponding time and continuously uses the allocated persistent resource from the subsequent period if UL persistent allocation is made in a UL subframe indicated by the UL basic assignment A-MAP IE.

When UL HARQ for the M2M device is not performed at the time UL persistent allocation is established for the M2M device (that is, no retransmission is performed in the corresponding subframe), the BS transmits a UL basic assignment A-MAP IE message having the resource index field set to 0b11111111111 to the M2M device.

Upon reception of the UL M2M basic assignment A-MAP IE including the resource index field having bits all set to 1, the M2M device de-allocates the UL allocated UL persistent resource only in the corresponding subframe and continuously uses the allocated persistent resource from the subsequent period if UL HARQ is not operated (that is, there is no UL burst to be retransmitted) and uplink persistent allocation has been made.

According to the above-mentioned embodiments of the present invention, when a resource region allocated according to long cycle persistent scheduling at a specific time is occupied by traffic of an existing MS, the BS can reduce scheduling complexity and prevent generation of a resource hole by changing the location of the resource region efficiently one time or temporarily several times.

The embodiments of the present invention described above are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in the appended claims may be presented in combination as an exemplary embodiment of the present invention or included as a new claim by subsequent amendment after the application is filed.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

Method of transmitting persistent scheduling change information at a base station (BS) is industrially applied to wireless communication system such as 3GPPL LTE, LTE, IEEE 802.16 standard, etc.

1. A method of transmitting persistent scheduling change information at a base station (BS) in a wireless communication system, the method comprising:
transmitting, to a machine-to-machine (M2M) device, a message comprising allocation period information including a persistent allocation period for the M2M device,
wherein the allocation period information indicates a temporary change or one-time reallocation when the allocation period information is set to a specific value, and
wherein the message further comprises changed resource allocation information when the allocation period information indicates the temporary change or one-time reallocation; and
receiving UL data from the M2M device through a resource indicated by the changed resource allocation information.

2. The method according to claim 1, wherein the set specific value is 0b1111.

3. The method according to claim 1, wherein the message is a UL M2M persistent allocation A-MAP IE (Information Element) message.

4. (canceled)

5. The method according to claim 1, further comprising:
receiving UL data through a persistent resource allocated before the message is received from the subsequent period, after the receiving of UL data from the M2M device through the resource indicated by the changed resource allocation information.

6. The method according to claim 1, wherein the resource indicated by the changed resource allocation information replaces a resource, which was previously persistently allocated for the same subframe as a subframe in which the message is transmitted, temporarily or one-time.

7. A method of receiving persistent scheduling change information at a machine-to-machine (M2M) device in a wireless communication system, the method comprising:
receiving a message comprising allocation period information including a persistent allocation period from a BS,
wherein the allocation period information indicates a temporary change or one-time reallocation when the allocation period information is set to a specific value, and
wherein the message further comprises changed resource allocation information when the allocation period information indicates the temporary change or one-time reallocation; and
transmitting UL data to the BS through a resource indicated by the changed resource allocation information.

8. The method according to claim 7, wherein the set specific value is 0b1111.

9. The method according to claim 7, wherein the message is a UL M2M persistent allocation A-MAP IE (Information Element) message.

10. (canceled)

11. The method according to claim 7, further comprising:
transmitting UL data through a persistent resource persistently allocated before receiving the message from the subsequent period, after the transmitting of UL data to the BS through the resource indicated by the changed resource allocation information.

12. The method according to claim 7, wherein the resource indicated by the changed resource allocation information replaces a resource, which was previously persistently allocated for the same subframe as a subframe in which the message is transmitted, temporarily or one-time.

13. A machine-to-machine (M2M) device for receiving persistent scheduling change information in a wireless communication system, the M2M device comprising:
a receiver configured to receive, from a BS, a message comprising allocation period information including a persistent allocation period,
wherein the allocation period information indicates a temporary change or one-time reallocation when the allocation period information is set to a specific value, and
wherein the message further comprises changed resource allocation information, when the allocation period information indicates a temporal change or one-time reallocation; and
a transmitter configured to transmit UL data to the BS through a resource indicated by the changed resource allocation information.

14. (canceled)

15. The M2M device according to claim 13, further comprising:
a processor configured to control the transmitter to transmit UL data through a persistent resource allocated before the message is received, after transmitting the UL data to the BS through the resource indicated by the changed resource allocation information,
wherein the transmitter is further configured to transmit UL data through the persistent resource allocated before the message is received, after transmitting the UL data to the BS.

16. A base station of transmitting persistent scheduling change information in a wireless communication system, the base station comprising:
a transmitter configured to transmit, to a machine-to-machine (M2M) device, a message comprising allocation period information including a persistent allocation period for the M2M device,
wherein the allocation period information indicates a temporary change or one-time reallocation when the allocation period information is set to a specific value, and
wherein the message further comprises changed resource allocation information when the allocation period information indicates the temporary change or one-time reallocation; and
a receiver configured to receive UL data from the M2M device through a resource indicated by the changed resource allocation information.

17. The base station according to claim 16, wherein the receiver is further configured to receive UL data through a persistent resource allocated before the message is received from the subsequent period, after the receiving of UL data from the M2M device through the resource indicated by the changed resource allocation information.

18. The base station according to claim 16, wherein the resource indicated by the changed resource allocation information replaces a resource, which was previously persistently allocated for the same subframe as a subframe in which the message is transmitted, temporarily or one-time.

19. The base station according to claim 16, wherein the set specific value is 0b1111.
